(19) United States
(12) Patent Application Publication
(10) Pub. No.: US 2018/0124837 A1
(43) Pub. Date: May 3, 2018

(54) METHOD AND APPARATUS FOR RANDOM ACCESS IN MILLIMETER WAVE SYSTEMS

(71) Applicant: Samsung Electronics Co., Ltd., Suwon-si (KR)

(72) Inventors: Hyunkyu YU, Suwon-si (KR); Hyukmin SON, Hanam-si (KR)

(21) Appl. No.: 15/802,880

(22) Filed: Nov. 3, 2017

(30) Foreign Application Priority Data
Nov. 3, 2016 (KR) 10-2016-0146076

(51) Int. Cl. H04W 74/08; H04B 7/06; H04B 7/0408; H04B 7/0404; H04W 16/28; H04W 72/04

(52) U.S. Cl. CPC H04W 74/0833; H04B 7/0617; H04B 7/0408; H04B 7/0639; H04W 72/042; H04B 7/0404; H04B 7/0695; H04W 16/28; H04W 72/0413; H04B 7/0691

(57) ABSTRACT

A communication technique in which a fifth generation (5G) communication system for supporting increases in high data transmission rate(s) after a fourth generation (4G) system converges with an Internet of things (IoT) technology, and a system thereof are provided. The system may be applied to intelligent services (e.g., smart hole, smart building, smart city, smart car or connected car, healthcare, digital education, retail business, security and safety-related services) based on a 5G communication technology and IoT-related technology. The present disclosure includes a structure of a signal and a channel, and an operation method and apparatus for supporting random access for a system capable of expecting remarkable increase(s) in communication capacity using beamforming on a wide frequency band in next generation communication supporting a millimeter wave (mmWave) band.

### CROSS-REFERENCE TO RELATED APPLICATION(S)

This application claims the benefit under 35 U.S.C. § 119(a) of a Korean patent application filed on Nov. 3, 2016 in the Korean Intellectual Property Office and assigned Serial number 10-2016-0146076, the entire disclosure of which is hereby incorporated by reference.

### TECHNICAL FIELD

Efforts to develop an improved fifth generation (5G) communication sys tem after the commercialization of the fourth generation (4G) communication system have been conducted. The main features of the 5G communication system compared to the 4G communication system are a high data transmission rate, a low communication latency, and a massive connection support. The present disclosure relates to a signal, a channel structure, and an operating method and apparatus for supporting a random access for a system capable of drastically increasing communication capacity using beamforming on a wide frequency band in a next generation communication supporting a millimeter wave (mmWave) band.

### BACKGROUND

To meet a demand for radio data traffic that is on an increasing trend since commercialization of a fourth generation (4G) communication system, efforts to develop an improved fifth generation (5G) communication system or a pre-5G communication system have been conducted. For this reason, the 5G communication system or the pre-5G communication system is called a beyond 4G network communication system or a post long term evolution (LTE) system. To achieve a high data transmission rate, the 5G communication system is considered to be implemented in a very high frequency millimeter wave (mmWave) band (e.g., like 60 GHz band). To relieve a path loss of a radio wave and increase a transfer distance of the radio wave in the very high frequency band, in the 5G communication system, beamforming, massive multiple input multiple output (MIMO), full dimensional MIMO (FD-MIMO), array antenna, analog beam-forming, and large scale antenna technologies have been discussed. Further, to improve a network of the system, in the 5G communication system, technologies such as an evolved small cell, an advanced small cell, a cloud radio access network (cloud RAN), an ultra-dense network, a device to device communication (D2D), a wireless backhaul, a moving network, cooperative communication, coordinated multi-points (CoMP), and reception interference cancellation have been developed. In addition to this, in the 5G system, hybrid frequency shift keying (FSK) and quadrature amplitude modulation (QAM) modulation (FQAM) and sliding window superposition coding (SWSC) that are an advanced coding modulation (ACM) scheme and a filter bank multi carrier (FBMC), a non orthogonal multiple access (NOMA), and a sparse code multiple access (SCMA) that are an advanced access technology, and so on have been developed.

Meanwhile, the Internet is evolved from a human-centered connection network through which a human being generates and consumes information to the Internet of things (IoT) network that transmits/receives information between distributed components such as things and processes the information. The Internet of everything (IoE) technology in which the big data processing technology, etc. is combined with the IoT technology by connection with a cloud server, etc. has also emerged. To implement the IoT, technology elements, such as a sensing technology, wired and wireless communication and network infrastructure, a service interface technology, and a security technology, have been required. Recently, technologies such as a sensor network, machine to machine (M2M), and machine type communication (MTC) for connecting between things have been researched. In the IoT environment, an intelligent Internet technology (IT) service that creates a new value in human life by collecting and analyzing data generated in the connected things may be provided. The IoT may apply for fields, such as a smart home, a smart building, a smart city, a smart car or a connected car, a smart grid, health care, smart appliances, and an advanced healthcare service, by fusing and combining the existing information technology (IT) with various industries.

Therefore, various tries to apply the 5G communication system to the IoT network have been conducted. For example, the 5G communication technologies, such as the sensor network, the machine to machine (M2M), and the machine type communication (MTC), have been implemented by techniques such as the beamforming, the MIMO, and the array antenna. The application of the cloud radio access network (cloud RAN) as the big data processing technology described above may also be considered as an example of the fusing of the 5G communication technology with the IoT technology.

In accordance with recent development of LTE and LTE-advanced (LTE-A), there is a demand for a method and apparatus for supporting random access for a system capable of expecting remarkable increase in communication capacity using beamforming on a wide frequency band in next generation communication supporting a mmWave band.

The above information is presented as background information only to assist with an understanding of the present disclosure. No determination has been made, and no assertion is made, as to whether any of the above might be applicable as prior art with regard to the present disclosure.

### SUMMARY

According to the related art, beamforming in a base station/terminal is a beamforming method in a digital domain and dose not consider application of beamforming in an analog domain. For analog beamforming, application in a communication system of a high frequency band with less physical limitations of an antenna is easy, and a fifth generation (5G) communication system considers use of ultra-high frequency millimeter wave (mmWave) band (for example, 30 GHz and 60 GHz) capable of having a wide bandwidth to implement a high data rate. In the ultra-high frequency band, since path-loss of radio wave is mitigated, and a transmission distance of radio wave becomes short, use of the analog beamforming technology is under discussion.

Aspects of the present disclosure are to address at least the above-mentioned problems and/or disadvantages and to provide at least the advantages described below. Accordingly, an aspect of the present disclosure is to provide an apparatus and method for accessing the base station after initial access through beamforming, random access based on beamforming in an analog domain in the base station/terminal needs to be performed, which has not been described yet in detail. Further, if a plurality of Tx Rx points (TRPs) exist in one cell, an operation for a random access process with the plurality of TRPs needs to be designed.

In accordance with an aspect of the present disclosure, a method for processing a control signal in a wireless communication system is provided. The method includes receiving a first control signal transmitted from a base station, processing the received first control signal, and transmitting a second control signal generated based on the processing to the base station.

According to the embodiment of the present disclosure, in order to implement a high data rate, one of requirements of the 5G communication system, stable random access is enabled in an mmWave band through the design of the analog beam-based synchronization signal and system information transmission signal, and the base station and terminal operation methods.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an example of a long term evolution (LTE) random access process according to an embodiment of the present disclosure;

FIG. 2 illustrates a process of transmitting base station beam information according to an embodiment in a random access process in a millimeter wave (mmWave) system according to an embodiment of the present disclosure;

FIG. 3 illustrates a process of transmitting one base station beam information according to an embodiment at the time of transmitting one or more random access requests according to an embodiment of the present disclosure;

FIG. 4 illustrates a process of transmitting one or more base station beam information according to an embodiment at the time of transmitting one or more random access requests according to an embodiment of the present disclosure;

FIG. 5 illustrates a process of transmitting one base station beam information through one or more random access responses (RARs) according to an embodiment at the time of transmitting one or more random access requests according to an embodiment of the present disclosure;

FIG. 6 illustrates a process of transmitting one or more base station beam information through each RAR according to an embodiment at the time of transmitting one or more random access requests according to an embodiment of the present disclosure;

FIG. 7 illustrates a process in a case in which one or more base station beam information are all transmitted through each RAR according to an embodiment at the time of transmitting one or more random access requests according to an embodiment of the present disclosure;

FIG. 8 illustrates an indication process and method for distinguishing a Tx Rx points (TRP) in a random access process according to an embodiment of the present disclosure;

FIG. 9 illustrates a method and process of transmitting one base station beam information at the time of transmitting one or more random access requests and corresponding TRP indication according to an embodiment of the present disclosure;

FIG. 10 illustrates a process of transmitting one base station beam information and a corresponding virtual TRP ID through one or more RARs according to an embodiment at the time of transmitting one or more random access requests according to an embodiment of the present disclosure;

FIG. 11 illustrates a process of transmitting one or more base station beam information together with corresponding virtual TRP IDs through an RAR according to an embodiment at the time of transmitting one or more random access requests according to an embodiment of the present disclosure;

FIG. 12 illustrates a process in a case in which one or more base station beam information and corresponding virtual TRP ID information are all transmitted through each RAR according to an embodiment at the time of transmitting one or more random access requests according to an embodiment of the present disclosure;

FIG. 13 illustrates an example of a mapping table for transmission mode configuration from a plurality of TRPs according to an embodiment of the present disclosure;

FIG. 14 illustrates a process of transmitting one or more base station beam information, corresponding virtual TRP IDs, and transmission mode configuration through each RAR according to an embodiment at the time of transmitting one or more random access requests according to an embodiment of the present disclosure;

FIG. 15 illustrates an example of a mapping table for split control/data transmission mode configuration from a plurality of TRPs according to an embodiment of the present disclosure;

FIG. 16 illustrates a block diagram of a configuration of a terminal according to an embodiment of the present disclosure according to an embodiment of the present disclosure; and

FIG. 17 illustrates a block diagram of a configuration of a base station according to an embodiment of the present disclosure according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, the definitions descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Various advantages and features of the present disclosure and methods accomplishing the same will become apparent from the following detailed description of embodiments with reference to the accompanying drawings. However, the present disclosure is not limited to the embodiments disclosed herein but will be implemented in various forms. The embodiments have made disclosure of the present disclosure complete and are provided so that those skilled in the art can easily understand the scope of the present disclosure. Therefore, the present disclosure will be defined by the scope of the appended claims. Like reference numerals throughout the description denote like elements.

In describing a configuration and an operation according to the present disclosure, the following system is assumed. The present disclosure is a technology that may be applied to the current system universally in a non-restrictive way.

An initial access-related synchronization and system information signal and channel are transmitted by analog beams operated by the base station in a beam sweeping manner. An initial synchronization process in which the base station repeatedly transmits corresponding signal through each analog beam, the terminal receives a primary synchronization signal (PSS) and secondary synchronization signal (SSS) while sweeping the reception beam for synchronization, and a physical broadcast channel (PBCH) is received to acquire system information is assumed. In the initial access process, the terminal acquires information on the terminal transmission beam and the base station reception beam that may be used for random access and performs the random access based on the information on a random access resource region associated there with.

The present disclosure includes a signal transmission method, process, base station/terminal operation method and apparatus related to random access.

### [Beam Information Indication Method and Process Through Random Access Process]

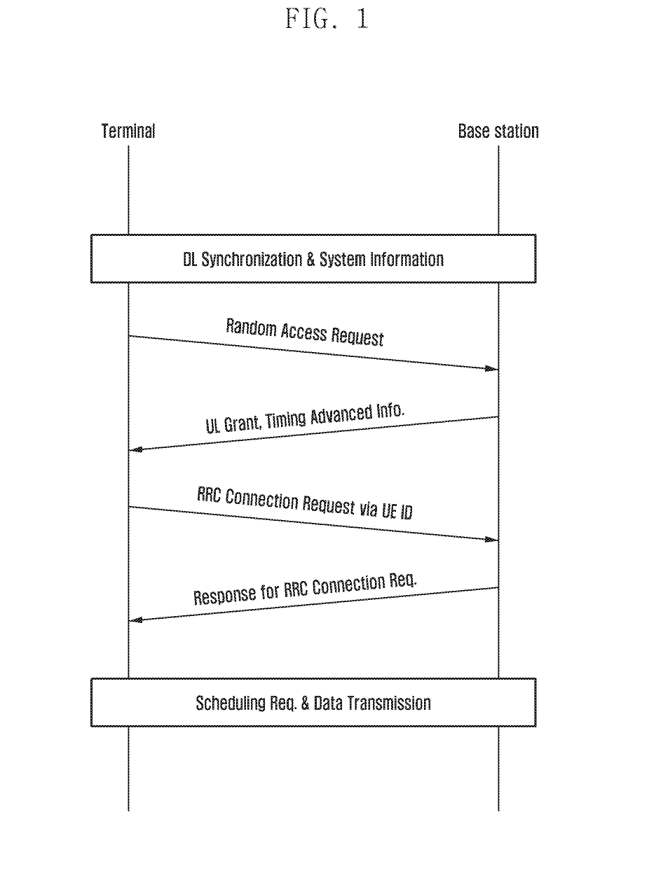

FIG. 1 illustrates an example of a long term evolution (LTE) random access process according to an embodiment of the present disclosure.

In the LTE, as illustrated in FIG. 1, a random access process is performed across four steps. The terminal selects any preamble in a random access resource region based on synchronization and system information acquired in the initial access process and transmits the selected preamble. The base station generates an temporary terminal identifier (ID) (random access radio network temporary identifier (RA-RNTI)) based on a resource index of the corresponding preamble, or the like and transmits a physical downlink control channel (PDCCH) and a physical downlink share channel (PDSCH) corresponding thereto based on the corresponding ID. In the corresponding step, as a random access response (RAR), information on resource allocation for uplink, timing for uplink, and the like are transmitted. The terminal performs the RRC connection request through uplink based on the corresponding information. Thereafter, the base station transmits a response for the corresponding request.

The following is contents related to a millimeter wave (mmWave) system based random access process, which may be applied to the initial access and all cases of performing random access later. It may be contention-based random access, or non-contention-based random access in which the preamble is dedicatedly allocated.

At the time of performing beamforming-based random access in the mm Wave system, the terminal may acquire beam information for a preamble signal transmitted in a first step as in FIG. 1 as follows. However, it is limited to a case in which channel reciprocity (or beam correspondence) is established.

In the case in which the beam correspondence in the terminal is established, the reception beam of the terminal may be used as the transmission beam of the terminal. That is, the terminal uses the corresponding reception beam at the time of transmission, and transmits an uplink preamble signal to some regions of a random access resource. The selection of the corresponding resource region is for a resource associated with the base station transmission beam. As an example, the base station transmission beam may be a beam transmitting a synchronization signal (SS block), and the corresponding transmission beam index may be signaled as an index of the synchronization signal block. In the case in which the beam correspondence in the base station is also established, the terminal may find information on the preferred base station transmission beam and the base station transmission beam may be used as the base station reception beam, the preamble is thus transmitted once to the random access resource region associated with the corresponding transmission beam. The terminal that did not receive the RAR in an RAR window section from the base station may retransmit the preamble signal.

The base station beam receiving the preamble may be implemented in a form of wide beam or a composite beam in which narrow beams for each antenna panel are combined in order to decrease overhead of resources. In this case, the base station detects a random access channel (RACH) preamble for each antenna panel, thereby measuring signal strength based on the narrow beam for each panel and acquiring base station narrow beam information for a specific terminal transmitting the preamble.

In the case of acquiring the corresponding information, the base station may use the corresponding narrow beam at the time of transmitting a second signal in FIG. 1. At this time, the base station may transmit information on the corresponding narrow beam to the terminal through the second signal. The corresponding information may be referred to as an SS block index or channel state information reference signal (CSI-RS) resource. Thereafter, communication is performed by configuring transmission and reception beams of the base station and the terminal based on the corresponding narrow beam at the time of transmitting and receiving third and fourth signals. Further, the base station may allocate a beam-related reference signal (e.g., CSI-RS) through the second signal based on the corresponding narrow beam information. The terminal reports beam-related information (e.g., information of N candidate beams and corresponding reference signal received power (RSRP)) measured based on the reference signal according to an instruction of the base station. If the terminal acquires information on the base narrow beam through a random access process, beam tracking may be efficiently performed through the beam-related reference signal based on a correspond ing base station beam direction after the random access process.

If the terminal acquires information of one or more available base station beams, the terminal may transmits a preamble through the corresponding beams in one or more random access resource regions. According to an embodiment, if there is a terminal transmitting a preamble to two random access resource regions, the following base station/terminal operations may be possible. Here, the resource region basically means a RACH preamble transmission section configured through time-division multiplexing (TDM), and the base station indicates that transmission may be performed through one or more beams when providing information on configuration for a specific RACH resource.
A case in which the base station transmits two RARs for each preamble transmission, that is, in a case of generating a temporary terminal ID (for example, RA-RNTI in the LTE) based on a type of preamble and a received random access resource position
In a case in which a beam of the terminal is different at the time of preamble transmission, if two reception beams may not be used at the time of RAR reception, only one RAR is received. At this time, the base station indicates information on the used base station transmission beam in the corresponding RAR from this time forward. Further, the terminal performs communication using a terminal beam corresponding to the corresponding base station beam in a subsequent communication process.

In a case in which a beam of the terminal is the same at the time of preamble transmission, when receiving two RARs, the terminal performs communication using a terminal beam corresponding to a base station beam indicated by the base station in the RAR. If the base station indicates that one or more beams are used, the communication is performed using one terminal beam for two beams.
In a case in which the base station transmits one RAR for a plurality of preambles transmitted by the terminal, an RA-RNTI is generated based on one specific resource among two or more random access resources. According to an embodiment, an RA-RNTI is generated based on a random access resource that is in ahead in terms of time among two or more random access resources. Alternatively, only a random access resource index which is common for two or more preambles is used at the time of generating the RA-RNTI (e.g., the same preamble sequence index). The base station may not distinguish the terminal with a region for distinguishing a reception beam since the base station does not know at which base station reception beam point in time the terminal performs transmission. Further, in the case of non-contention-based RACH transmission, as a specific preamble sequence is allocated to the terminal in advance, it is possible to know which terminal transmits each of a plurality of preambles.
In a case in which a beam of the terminal is different at the time of preamble transmission, the base station transmits the same RAR using two beams. Alternatively, the base station transmits the RAR using one beam having greater received preamble strength among two beams. —In a case in which a beam of the terminal is the same at the time of preamble transmission, the base station transmits the RAR using one or two beams. In both of the two cases, the base station may perform subsequent communication using a terminal beam corresponding to a base station beam indicated in the RAR.

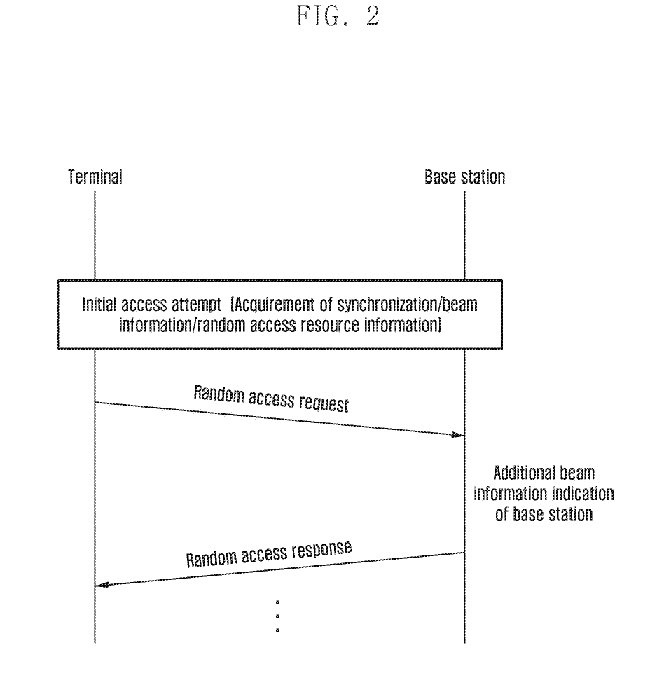

FIG. 2 illustrates an operation process in which the base station transmits additional beam information acquired from a random access request (i.e., preamble transmission) reception process to the terminal through an RAR when the terminal transmits a preamble to one random access resource region at the time of performing random access in the mmWave band according to an embodiment of the present disclosure.

The additional beam information means beam information other than information the terminal knows about the base station beam. In a case in which a random access request based on the base station beam information known by the terminal, that is, information on the fact that a composite beam transmitting the initial access signal (i.e., a beam consisting of narrow beams 2, 4, 6, and 8) is preferred, is transmitted to a random access resource region associated with the base station beam, the base station may additionally give an indication that beam 2 or beam 4 is preferred to the terminal through the preamble reception.

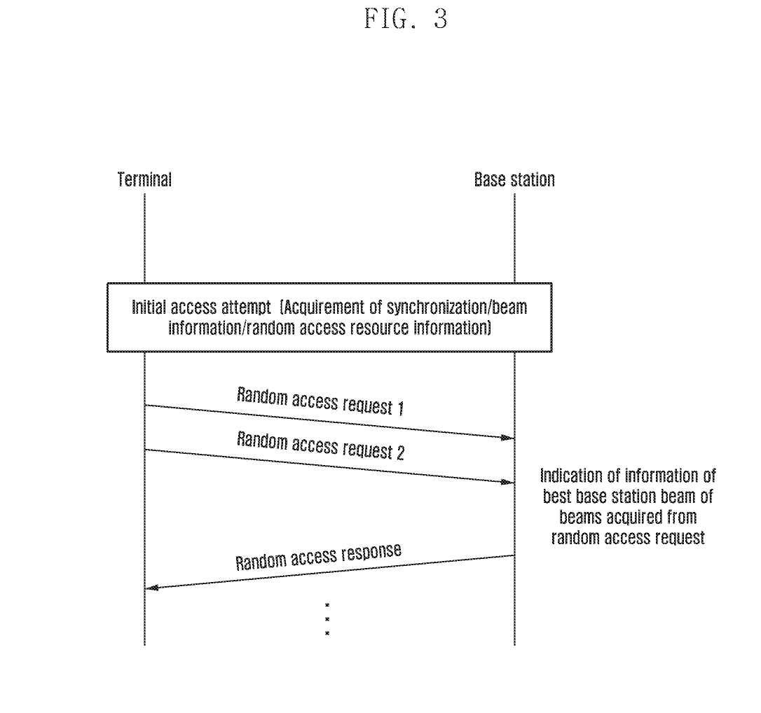

FIG. 3 is described under an assumption that the base station acquires a narrow beam that is most preferred for transmission and reception in a composite beam that each random access request is attempted as described with reference to FIG. 2.

FIG. 3 illustrates an operation process in which the base station transmits one or more beam information acquired from each random access request (i.e., preamble transmission) to the terminal through an RAR when the terminal transmits a preamble to one or more random access resource regions at the time of performing random access in the mmWave band according to an embodiment of the present disclosure. FIG. 3 illustrates an operation for a case in which one beam information is transmitted and an operation on the premise that connection between the base station and the terminal is maintained using one beam, and illustrates a process of indicating information on the best beam in beam information acquired through each random access request to the terminal according to an embodiment.

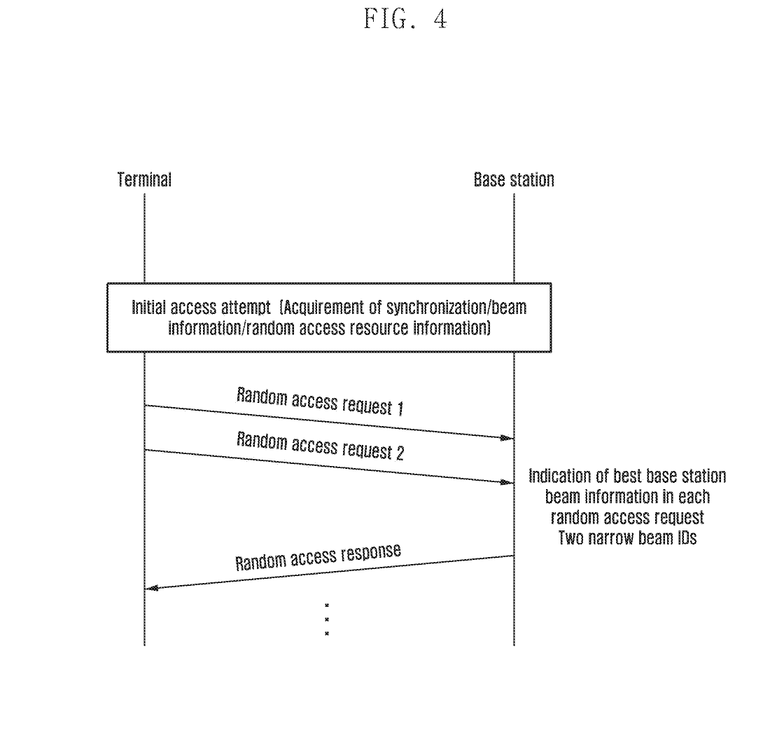

FIGS. 3 and 4 are cases in which an RAR is transmitted using one temporary terminal ID (e.g., RA-RNTI) according to various embodiments of the present disclosure, and one or more RARs may be transmitted from the base station for each random access request at the time of transmitting one or more random access requests.

Referring to FIG. 3, one RAR may be transmitted based on a temporary terminal ID associated with a selected beam. If two RARs are independently transmitted, the same best base station beam information will be included in the RARs and transmitted. However, an actually transmitted beam will be transmitted using each temporary terminal ID based on each random access request beam.

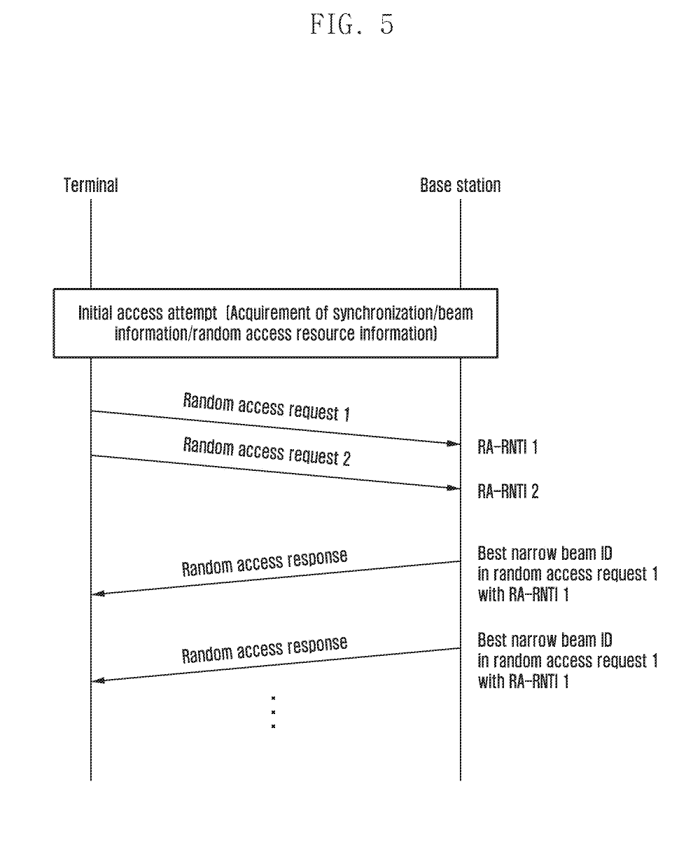

FIG. 5 illustrates a corresponding base station/terminal operation process in a case in which a beam related to a first request in two random access requests is selected by the base station. Thereafter, the temporary terminal ID or RA-RNTI is used for the same meaning, and the corresponding ID is on the premise that it is used for generating a scrambling sequence of the PDCCH or cyclic redundancy check (CRC) masking.

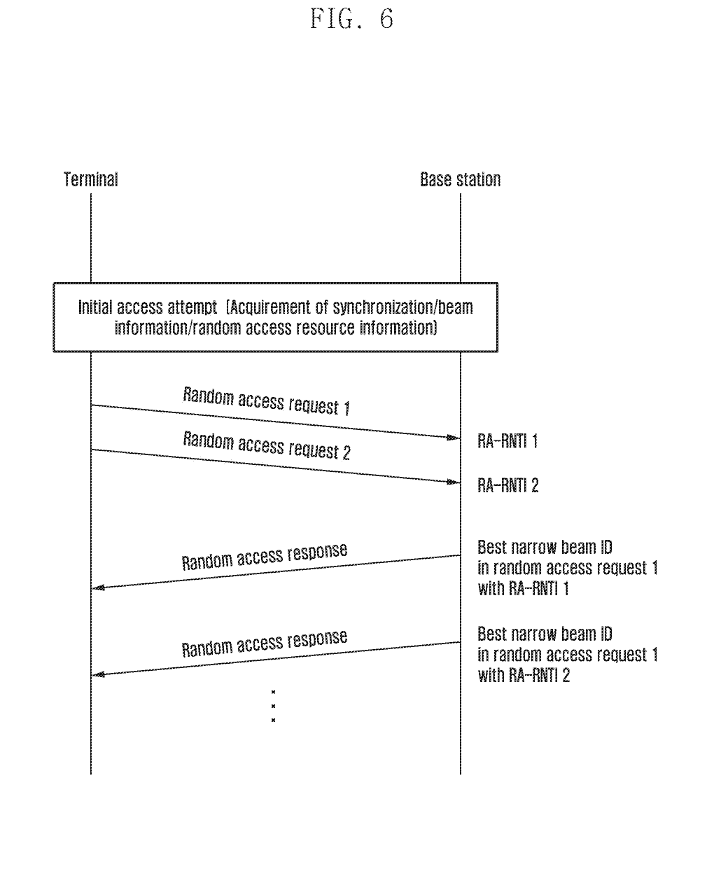

FIG. 6 illustrates a corresponding base station/terminal operation process in a case in which a best beam related to each request in two random access requests is selected by the base station according to an embodiment of the present disclosure.

Each RAR corresponding to each request may include both of two beam information selected by the base station, or may include only one beam information corresponding to each request. FIG. 6 illustrates a case in which each RAR includes only each beam information according to an embodiment.

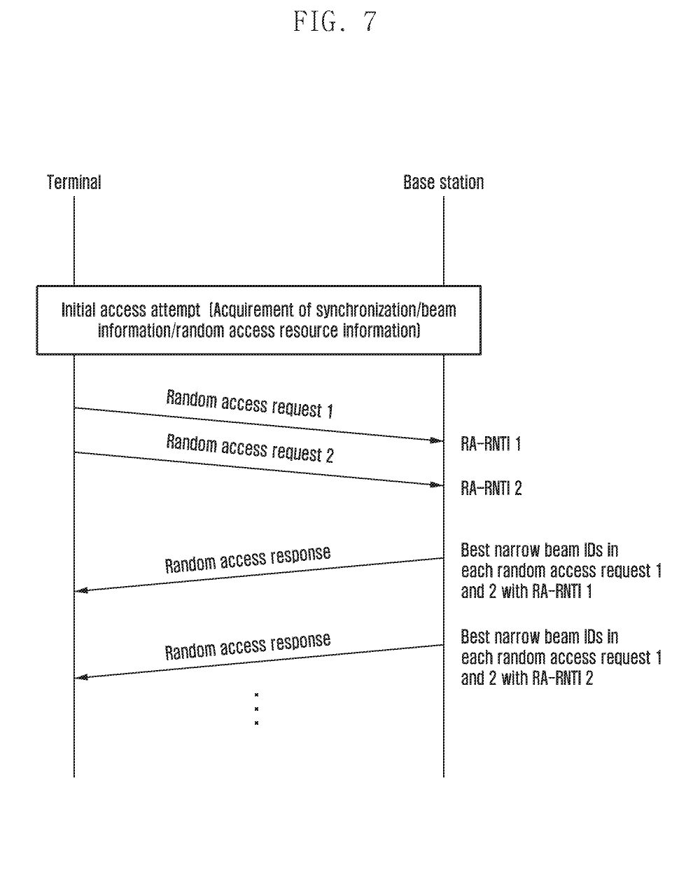

FIG. 7 illustrates a case in which both two beam information are include d according to an embodiment of the present disclosure.

The beam information included in the RAR by the base station may be an indication for one or more base station beams. This enables efficient beam management of the base station and the terminal and allows the base station to perform communication with the terminal using a plurality of beams. The embodiment in which the beam information indication by the base station is included in an RAR has been described above, however, the present disclosure is not limited thereto. The beam information indication by the base station may be included in a downlink signal transmitted by the base station to the terminal in the random access process, other than the RAR.

### [TRP Information Indication Method and Process Through Random Access Process]

In a case in which multiple TRPs exist in one cell, after performing RRC connection through a random access process after acquiring base station/terminal beam information in the initial access process, the terminal may not acquire information on with which TRP the connection is still maintained. The present disclosure proposes a method and process in which the terminal may acquire information on with which specific TRP among multiple TRPs the connection is made in the random access process.

If multiple TRPs exist in one cell, each TRP may be distinguished by the following method.
Distinguishment of TRPs through orthogonal resource allocation, that is, when the number of base station beams operated in one cell is 100, an entire frame structure may be a structure in which resources supporting sweeping of 100 beams are allocated. Therefore, the resources allocated for 100 beams may be orthogonally divided and used by each TRP, and beam IDs for each of 100 beams may be used to distinguish the TRPs. For example, if there are two TRPs in one cell, beam IDs 0 to 49 may be beam IDs used at a first TRP, and beam IDs 50 to 99 may be beam IDs used at a second TRP. Here, the beam ID may more specifically mean a resource index of an SS block or CSI-RS.
It is possible to distinguish a TRP by generating virtual TRP IDs and mapping the virtual TRP IDs to multiple TRPs in one cell. Alternatively, all beams operated in one cell may be grouped into multiple beam groups, and corresponding beam group IDs may be used for distinguishing TRPs. In the present disclosure, an operation using a beam group ID instead of a virtual TRP ID is also possible, and but for convenience of explanation, a case of using the virtual TRP ID will be representatively described. Here, the terminal may not actually know information on a TRP, and a beam group ID or a virtual TRP ID may be recognized as a group of a CSI-RS resource or SS block.

Among the two method described above, in the case in which TRPs are distinguished based on a beam ID, TRPs may be simultaneously distinguished by including a beam ID in an RAR or a downlink signal other than the RAR in a previous random access process.

In the case in which TRPs are distinguished using a virtual TRP ID, it is possible to know from which TRP a corresponding beam is transmitted, by including a virtual TRP ID other than the beam ID information in an RAR or a downlink signal of her than the RAR in the random access process.

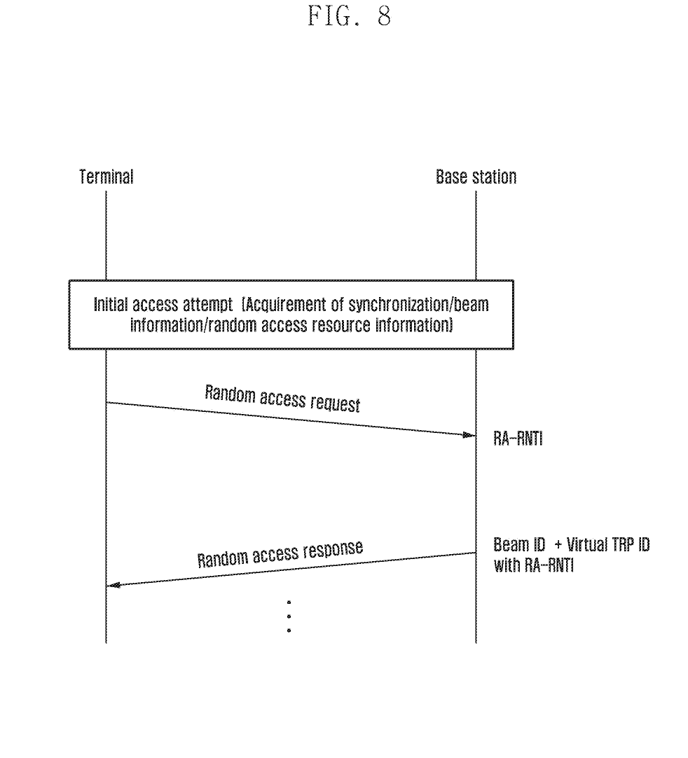

FIG. 8 illustrates a process in which a beam ID and a virtual TRP ID corresponding thereto are transmitted based on an RA-RNTI by RAR transmission according to one random access request according to an embodiment of the present disclosure.

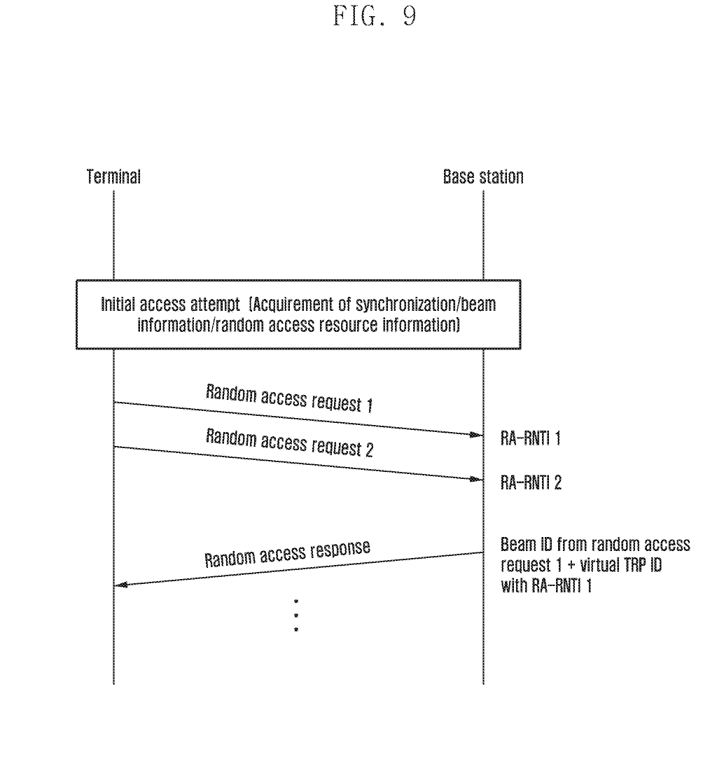

FIG. 9 illustrates a method and process of transmitting one base station beam information at the time of transmitting one or more random access requests and corresponding TRP indication according to an embodiment of the present disclosure.

Referring to FIG. 9, a process in which a beam corresponding to a first request of two random access requests is selected by the base station, and the corresponding beam information is transmitted together with a virtual TRP ID based on a corresponding RA-RNTI 1 is illustrated.

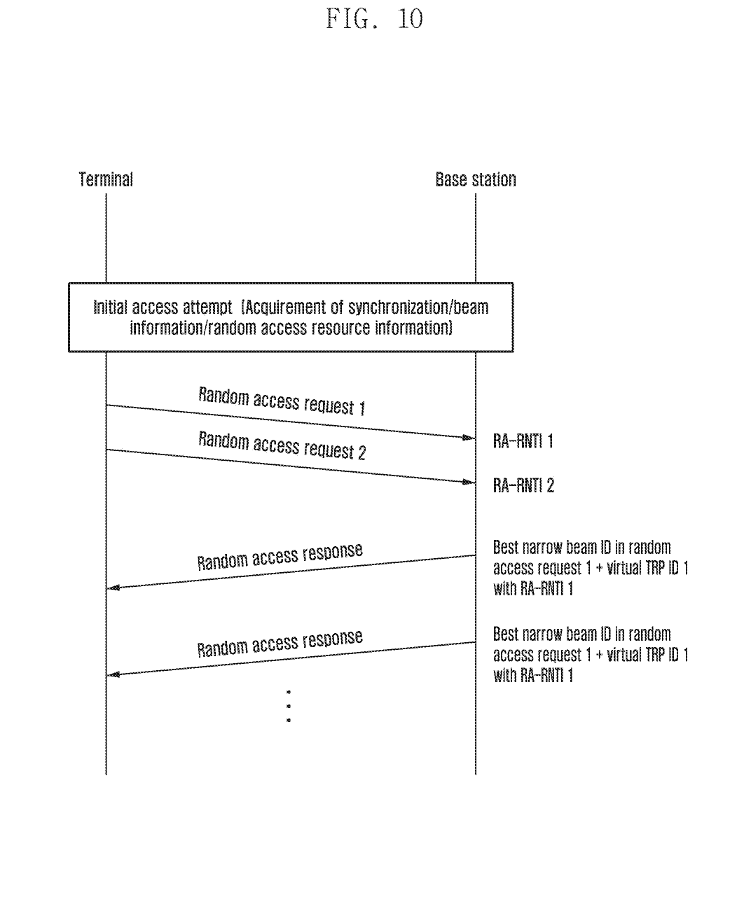

FIG. 10 illustrates a process of transmitting one base station beam information and a corresponding virtual TRP ID through one or more RARs according to an embodiment of the present disclosure at the time of transmitting one or more random access requests.

Referring to FIG. 10, a process in which when a beam corresponding to a first request of two random access request is selected by the base station, the corresponding beam information is transmitted together with a corresponding virtual TRP ID based on an RA-RATI 1.

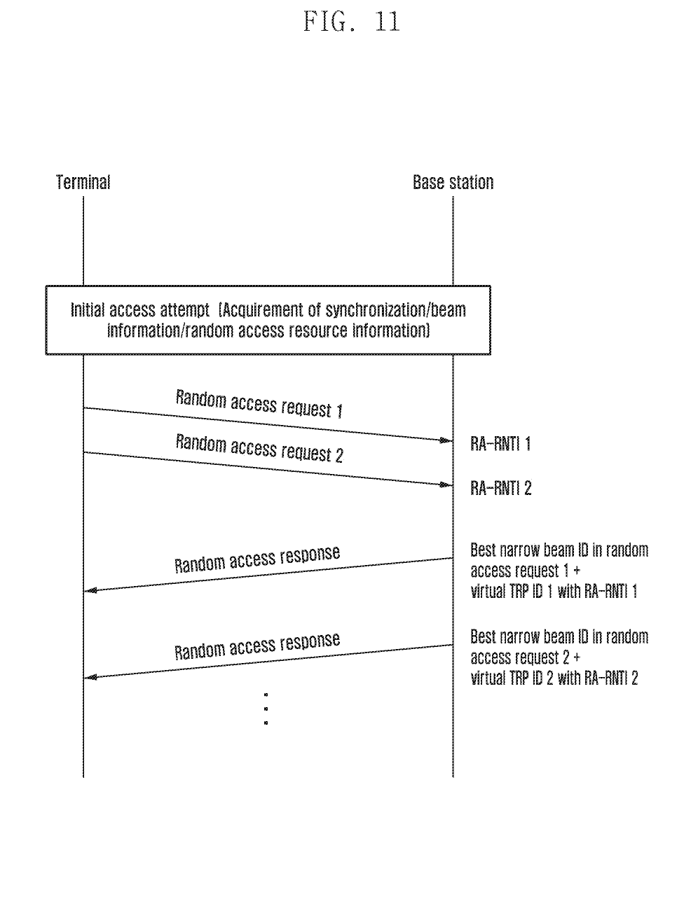

FIG. 11 illustrates a process of transmitting one or more base station beam information together with corresponding virtual TRP IDs through each RAR according to an embodiment of the present disclosure at the time of transmitting one or more random access requests.

Referring to FIG. 11, an example in which TRPs corresponding to two beams are different from each other, and thus indication for two TRP IDs is made.

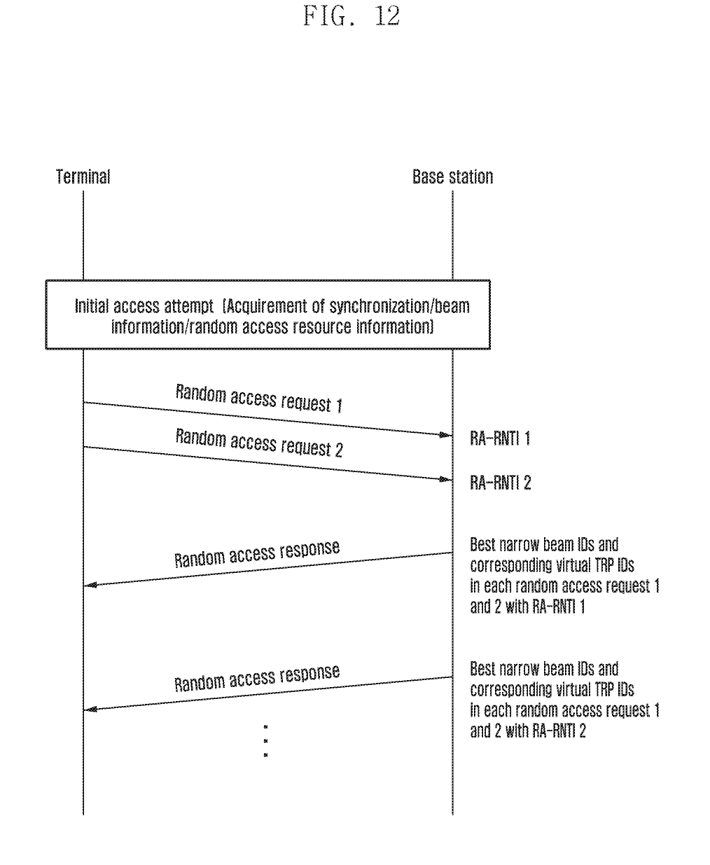

FIG. 12 illustrates a process of transmitting one or more base station beam information together with corresponding virtual TRP IDs through each RAR according to an embodiment of the present disclosure at the time of transmitting one or more random access requests.

Referring to FIG. 12, an example in which TRPs corresponding to two beams are different from each other, and thus indication for two TRP IDs is made.

If two or more random access requests are transmitted, and corresponding request messages are received by two or more TRPs, the terminal may maintain connection with one or more TRPs and data communication through the random access process. For convenience of explanation, if the terminal is connected with two TRPs through the random access process, the following communication modes may be selected
TRP selection: Receiving data from one TRP
Diversity mode transmission: Receiving the same data from one or more TRPs
Multiplexing mode transmission: Receiving different data from one or more TRPs
Split control/data reception mode: Receiving a control signal from one or more TRPs, and receiving data from TRPs except for the TRPs transmitting the control signal or receiving data from all TRPs

In the case of TRP selection mode, configuration may be made by the method as in FIGS. 9 and 10. According to the embodiment in FIGS. 11 and 12, for a support of the diversity/multiplexing modes from TRPs, indication for the corresponding transmission method in the RAR is required. In order to support the control signal and data reception mode, explicit and implicit indications are all possible. In the case of explicit mode, the corresponding indication may be directly included in the RAR and transmitted.

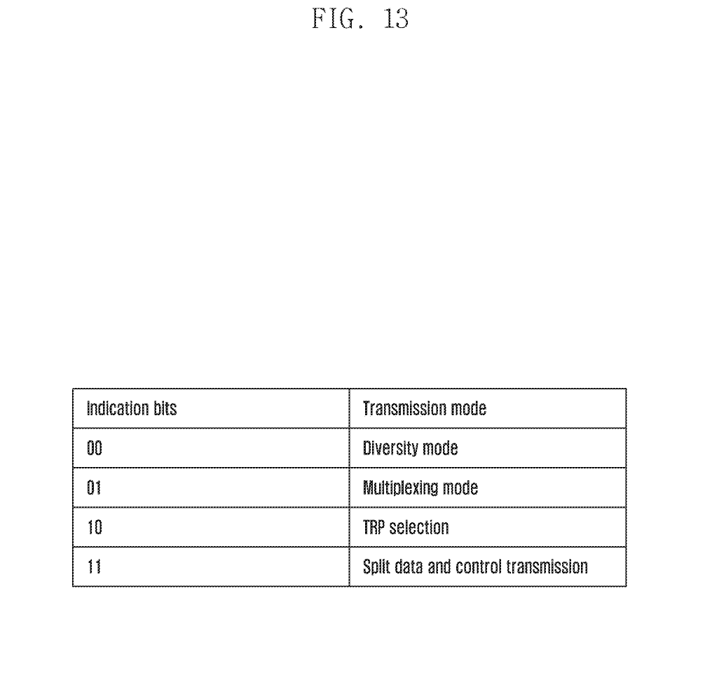

FIG. 13 illustrates an example of a mapping table for transmission mode configuration from a plurality of TRPs according to an embodiment of the present disclosure.

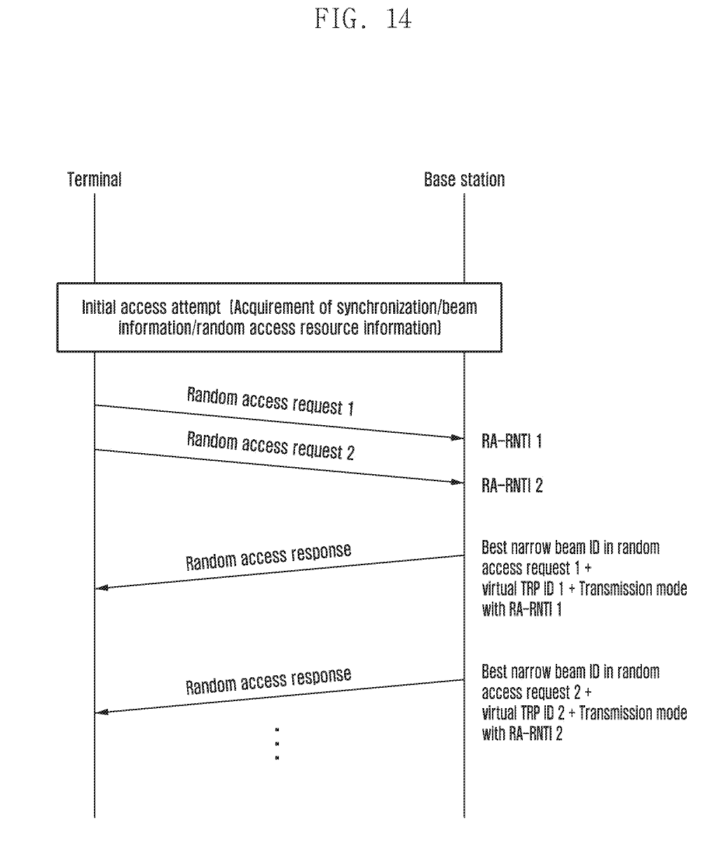

FIG. 14 illustrates a process of transmitting one or more base station beam information, corresponding virtual TRP IDs, and transmission mode configuration through each RAR according to an embodiment at the time of transmitting one or more random access requests according to an embodiment of the present disclosure.

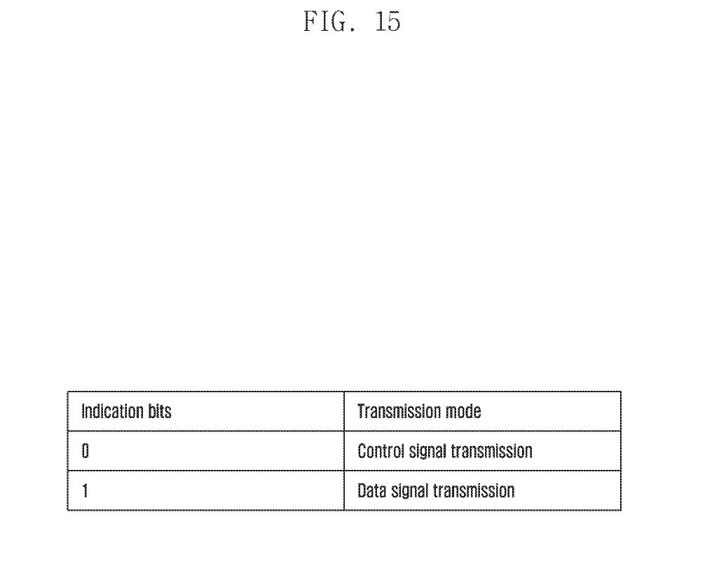

FIG. 15 illustrates an example of a mapping table for split control/data transmission mode configuration from a plurality of TRPs according to an embodiment of the present disclosure.

According to an embodiment, when 2 bit indication is made for indication for TRP selection/diversity/multiplexing/control signal & data transmission TRP separation, an example of a corresponding indication Table is as in FIG. 13, and a process of including the corresponding information is illustrated in FIG. 14 based on FIG. 11. It is not limited to the method in FIG. 11, but may be applied in various embodiments of RAR transmission, and the corresponding indication may be made in a downlink signal during the random access process, in addition to the embodiment of RAR transmission.

Referring to FIG. 13, in the case of “11”, indication for control signal transmission and data transmission TRP also needs to be additionally transmitted through an RAR.

Referring to FIG. 15, indication information is transmitted while being included in each RAR in FIG. 13 according to a mapping table for corresponding indication.

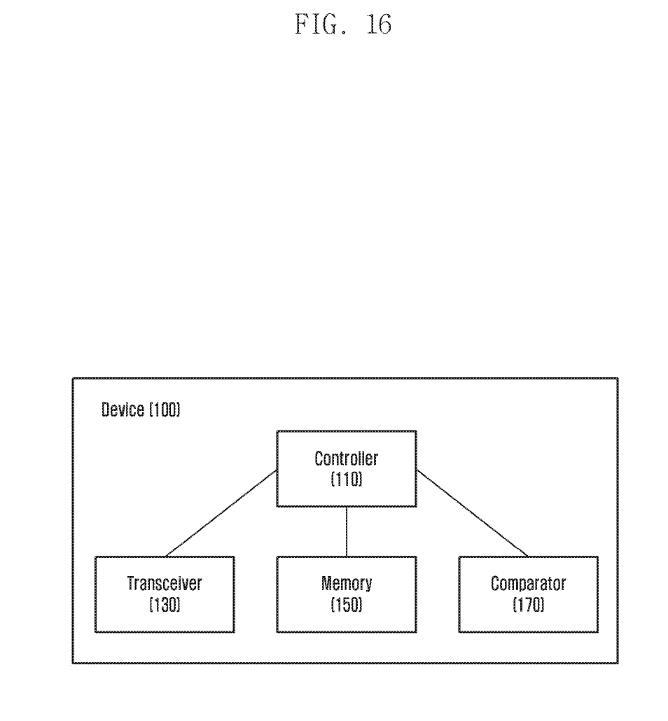

FIG. 16 illustrates a block diagram of a configuration of a device 100 according to an embodiment of the present disclosure.

Referring to FIG. 16, the terminal includes, for example, a controller 110 (e.g., at least one processor), a transceiver 130, a memory 150, and a comparator 170. Such a configuration of the terminal may be divided into more detail configurations or integrated into one configuration according to an embodiment or an intention of an operator.

The memory 150 stores information signaled by the base station or information buffered at the time of decoding. In the embodiment of the specification described above, all information stored in the terminal in advance are stored in the memory. The transceiver 130 receives a downlink signal according to the embodiments described above, receives a base station signal by applying terminal beamforming according to an indication of the controller 110, transmits a signal to the base station, and stores corresponding results in the memory 150. The controller 110 controls overall operations for the terminal in the embodiments described above. Further, the comparator 170 performs comparison and confirmation operations performed by the device 100 in the embodiments described above according to an indication of the controller 110. Description of detailed operations of each configuration will be omitted.

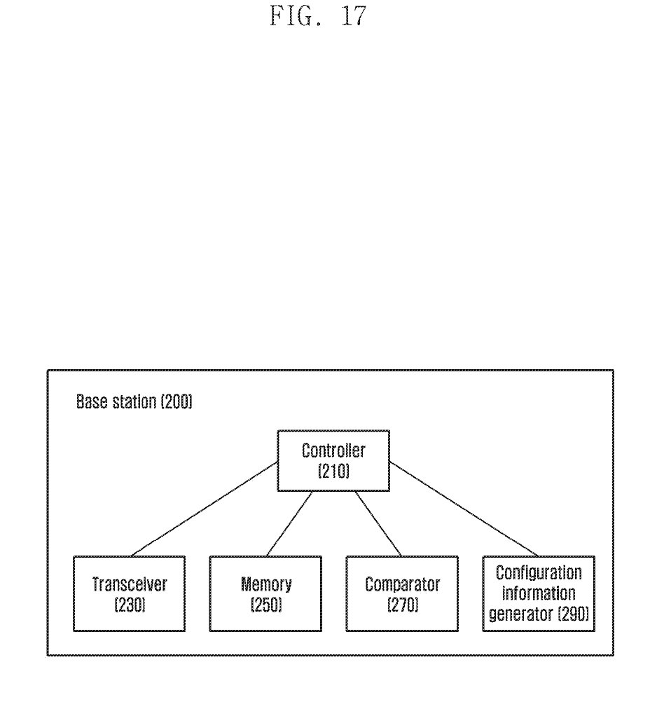

FIG. 17 illustrates a block diagram of a configuration of a base station 200 according to an embodiment of the present disclosure.

Referring to FIG. 17, the base station 200 includes, for example, a controller 210, a transceiver 230, a memory 250, a comparator 270, and a configuration information generator 290. Such a configuration of the base station 200 may be divided into more detail configurations or integrated into one configuration according to an embodiment or an intention of an operator. The comparator 270 performs comparison and confirmation operations for information received from the terminal according to an indication of the controller 210. The configuration information generator 290 generates information transmitted to each terminal according to an indication of the controller 210. The memory 250 stores configuration information transmitted to each terminal and the like. In the embodiments of the specification described above, all information stored in the base station 200 in advance are stored in the memory 250. The transceiver 230 transmits a downlink signal according to the embodiments described above. Particularly, in the present embodiment, beamforming-based signals are transmitted. The controller 210 controls overall operations for the terminal in the embodiments described above.

FIGS. 16 and 17 are described by way of example for convenience of explanation, and the device and the reception end according to an embodiment of the present disclosure may be variously configured. Further, the embodiments of the present disclosure may exist independently, or some or all of the embodiments may be applied together with at least one of other embodiments.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method by a user equipment (UE) during a random access procedure, the method comprising:
transmitting, to a base station, a random access request; and
receiving, from the base station, a random access response including beam information to be used in the base station.

2. The method of claim 1, wherein the beam information is indicated based on a channel state information reference signal (CSI-RS) resource or a synchronization signal (SS) block index.

3. The method of claim 1, further comprising:
receiving, from the base station, information on a beam group,
wherein the information on a beam group is indicated based on a group of CSI-RS resource or a group of a SS block.

4. The method of claim 1, further comprising:
generating a random access radio network temporary identifier (RA-RNTI) for a plurality of preambles based on at least one of a same preamble sequence index and a same frequency resource index, when the UE transmits the plurality of preambles to the base station.

5. A method by a base station during a random access procedure, the method comprising:
receiving, from a user equipment (UE), a random access request; and
transmitting, to the UE, a random access response including beam information to be used in the base station.

6. The method of claim 5, wherein the beam information is indicated based on a channel state information reference signal (CSI-RS) resource or a synchronization signal (SS) block index.

7. The method of claim 5, further comprising:
transmitting, to the UE, information on a beam group, the information on a beam group is indicated based on a group of CSI-RS resource or a group of a SS block.

8. The method of claim 5, further comprising:
generating a random access radio network temporary identifier (RA-RNTI) for a plurality of preambles based on at least one of a same preamble sequence index and a same frequency resource index, when the UE transmits the plurality of preambles to the base station.

9. A user equipment (UE) for performing a random access procedure, the UE comprising:
a transceiver configured to transmit and receive a signal; and
a controller coupled with the transceiver and configured to control:
transmitting, to a base station, a random access request, and
receiving, from the base station, a random access response including beam information to be used in the base station.

10. The UE of claim 9, wherein the beam information is indicated based on a channel state information reference signal (CSI-RS) resource or a synchronization signal (SS) block index.

11. The UE of claim 9,
wherein the controller is configured to control receiving, from the base station, information on a beam group, and
wherein the information on a beam group is indicated based on a group of CSI-RS resource or a group of a SS block.

12. The UE of claim 9, wherein a random access radio network temporary identifier (RA-RNTI) for a plurality of preambles is generated based on at least one of a same preamble sequence index and a same frequency resource index, when the UE transmits the plurality of preambles to the base station.

13. A base station for performing a random access procedure, the base station comprising:
a transceiver configured to transmit and receive a signal; and
a controller coupled with the transceiver and configured to control:
receiving, from a user equipment (UE), a random access request, and
transmitting, to the UE, a random access response including beam information to be used in the base station.

14. The base station of claim 13, wherein the beam information is indicated based on a channel state information reference signal (CSI-RS) resource or a synchronization signal (SS) block index.

15. The base station of claim 13,
wherein the controller is configured to control transmitting, to the UE, information on a beam group, and
wherein the information on a beam group is indicated based on a group of CSI-RS resource or a group of a SS block.

16. The base station of claim 13, wherein a random access radio network temporary identifier (RA-RNTI) for a plurality of preambles is generated based on at least one of a same preamble sequence index and a same frequency resource index, when the UE transmits the plurality of preambles to the base station.
